(19) United States
(12) Patent Application Publication
(10) Pub. No.: US 2026/0116154 A1
(43) Pub. Date: Apr. 30, 2026

(54) Air Diffuser for a Vehicle

(71) Applicant: Illinois Tool Works Inc., Glenview, IL (US)

(72) Inventors: Günther Krämer, Enkenbach-Alsenborn (DE); Laurent Le Tohic, Enkenbach-Alsenborn (DE)

(21) Appl. No.: 19/364,814

(22) Filed: Oct. 21, 2025

(30) Foreign Application Priority Data
Oct. 31, 2024 (DE) 10 2024 131 855.4

(51) Int. Cl. B60H 1/34

(52) U.S. Cl. CPC B60H 1/345; B60H 2001/3471

(57) ABSTRACT

An air vent (1) for a vehicle. The air vent (1) includes a housing (2) and a stationary flow body (5) inside it, around which air flow (F) can pass as it moves through the housing (2). The vent also includes an air-guiding assembly (6) with one or more air-guiding elements (7, 7.1). This assembly (6) is mounted so that it can pivot around at least one axis (8), moving between a neutral position and one or more deflected positions. When in its neutral position, the air-guiding assembly (6) is positioned—looking in the direction the air flow (F)—upstream of the flow body (5). In particular, it is arranged so that, when looking straight down at the air outlet area (4) of the housing (2), the air-guiding assembly (6) is not visible.

### RELATED APPLICATION

The present application claims the benefit of German Patent Application No. 102024131 855.4, filed October 31, 2024, titled “Air Diffuser for a Vehicle,” the contents of which are hereby incorporated by reference.

### BACKGROUND

In ventilation apparatuses for vehicles, air vents or air vent nozzles are typically used, which enable the exiting air flow to be controlled in a targeted manner. Such air vents are used in order to supply fresh air, in particular, into a motor vehicle interior.

The air flow flows through an inlet opening at an air inlet region of the air vent into the air duct, which is delimited by the housing wall of the air vent, through said air duct, and ultimately through an outlet opening at the air outlet region of the air vent into the interior of a motor vehicle (for example, a car or truck). The air flow generally follows a main flow direction, which can run in particular at least essentially parallel to a longitudinal axis of the housing of the air vent.

In known air vents, the air flow is deflected from the main flow direction by one or more air-guiding elements, for example pivotable air-guiding blades or fixed air-guiding elements. In addition to the air-guiding elements, the housing of the air vent that delimits the air duct can also serve to deflect the air from the main flow direction.

In particular, the region of an air vent that is visible from the interior of the motor vehicle, such as, in particular, the air outlet region of the housing, is increasingly used in order to generate attention among consumers and to enhance the overall appearance of the motor vehicle. In particular, the interior furnishing of a motor vehicle is an increasingly distinguishing feature and should be designed in order to create style and ambience as desired by the motor vehicle buyer.

Accordingly, there is also a need for air vents that blend harmoniously into the design theme of the vehicle interior.

The present disclosure generally relates to a ventilation system substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically and in a cross-sectional view shows an exemplary embodiment of an air vent according to the disclosure in a state in which the air-guiding element arrangement of the air vent is in a (fully) deflected position.

FIG. 2 illustrates schematically and in a sectional view shows the exemplary embodiment of the air vent according to FIG. 1, in a state in which the air-guiding element arrangement is in a neutral position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to an air vent, in particular for a ventilation system of a motor vehicle. Furthermore, the disclosure relates to a ventilation system having such an air vent as well as a corresponding air vent system.

One particular desire among experts is to specify, in the easiest possible way, an air vent that – when viewed from inside the vehicle – reflects the appearance of an aircraft jet nozzle, wherein the air flow regulating and/or air flow deflecting elements used to set the main direction of the air flow emitted by the air vent and/or to set the amount of air flow emitted by the air vent per unit of time are as invisible as possible.

In particular, the air vent should be designed such that only the lowest possible pressure loss occurs when the air flow can be directed as required.

In addition, there is a need to create such an air vent in particular, so that a particularly advantageous adjustability of the air vent can be realized in a particularly advantageous way.

This problem is solved according to the disclosure by the subject matter of the independent claim 1, wherein advantageous further developments of the air vent according to the disclosure are specified in the corresponding dependent claims.

Accordingly, the present disclosure relates, in particular, to an air vent for a motor vehicle, wherein the air vent comprises the following: a housing having an air inlet region and an air outlet region; a flow body arranged at least partially or regionally and preferably completely in the housing and around which an air flow flowing through the housing can flow, which flow body is designed to be stationary relative to the housing; and an air-guiding element arrangement having at least one air-guiding element, wherein the air-guiding element arrangement is mounted to be pivotable relative to the housing and relative to the flow body between a neutral position and at least one deflected position about at least one axis of rotation,

According to the disclosure, it is specifically provided that the air-guiding element arrangement is arranged at least in its neutral position – as seen in a main flow direction of the air flow flowing through the housing – upstream of the flow body, in particular such that the air-guiding element arrangement is not optically visible in a top view of the air outlet region of the housing of the air vent.

According to embodiments of the air vent according to the disclosure, it is envisaged that the air-guiding element arrangement has a plurality of air-guiding elements that run at least essentially parallel to one another and are arranged in particular in a fixed position relative to one another, which are pivoted together about one of the at least one axis of rotation as a common axis of rotation when the air-guiding element arrangement is adjusted, wherein the air-guiding elements of the air-guiding element arrangement form, in particular, a lamellar structure. For example, the air-guiding element arrangement is designed as an integrally formed or firmly assembled component with several lamellas, which is pivotably mounted in the housing. Preferably, the air-guiding element arrangement has, viewed in cross-section along the flow direction, two outer lamellae and at least one inner lamella arranged between the outer lamellae, e.g., two inner lamellae, so that there are a total of four lamellae, or three inner lamellae, so that there are a total of five lamellae.

In this context, it is advantageous that, at least in the neutral position of the air-guiding element arrangement, an air duct is formed between two adjacent air-guiding elements of the particularly lamellar structure, through which a portion of the air flow flowing through the housing flows.

For this purpose, it is conceivable that at least one outer air-guiding element and preferably both opposing outer air-guiding elements of the particularly lamellar structure and/or a wall section of the housing in the region of the air-guiding element arrangement are designed such that, particularly in the neutral position of the air-guiding element arrangement and preferably both in the neutral position and in the at least one deflected position of the air-guiding element arrangement, no air duct through which air flows is formed between the at least one outer air-guiding element and the wall section of the housing.

Advantageously, the wall section of the housing is at least partially or regionally curved and, in particular, is designed to be complementary to an outer surface of the at least one outer air-guiding element, wherein the outer surface of the at least one outer air-guiding element is, in particular, at least partially or regionally convexly curved.

According to embodiments of the air vent according to the disclosure, it is envisaged that – at least in a neutral position of the air-guiding element arrangement – air flows around or can flow around the flow body at least on two opposing sides.

In this context, it is conceivable that, viewed in cross-section along the flow direction, the flow body has an egg-shaped, oval-shaped, or drop-shaped embodiment.

Alternatively or additionally, in embodiment variants of the air vent according to the disclosure, it is provided that a wall region of the housing in the region of the flow body runs at least essentially parallel to a surface of the flow body opposing the wall region of the housing, and wherein – at least in the neutral position of the air-guiding element arrangement – a flow channel with, in particular, an at least essentially constant effective flow cross-section is formed between the wall region of the housing and the opposing surface of the flow body.

Alternatively or additionally, in design variants of the air vent according to the disclosure, it is provided that in a fully deflected position of the air-guiding element arrangement, at least one air-guiding element of the air-guiding element arrangement blocks at least one region of the flow channel formed between the wall region of the housing and the opposing surface of the flow body for air to flow through.

According to embodiments of the air vent according to the disclosure, it is envisaged that the air-guiding element arrangement is gimballed.

On the other hand, it is conceivable that the air vent comprises a control element that can be actuated manually in particular for manipulating the air-guiding element arrangement as required, wherein the control element is preferably at least partially or regionally incorporated or integrated into the flow body, or wherein the control element is preferably arranged at least partially or in part on the housing of the air vent.

In this context, it is advantageous for the control element to be gimballed and designed such that the air-guiding element arrangement is manipulated in the opposite direction when the control element is actuated.

According to embodiments of the air vent according to the disclosure, it is provided that the housing has a separation edge at the air outlet region of the housing which protrudes into a flow channel of the air vent and, in particular, projects into it.

Alternatively or in addition to this, the air vent has a device which is designed to eliminate or at least reduce or attenuate the Coandă effect occurring in particular when the air flow is deflected from the main flow direction at a region of the inner wall of the housing and/or at a wall region of the at least one air-guiding element.

Various solutions are possible for implementing the device for eliminating or reducing/attenuating the Coandă effect, and these can be combined with each other as desired.

Thus, according to embodiments of the air vent according to the disclosure, it is provided that the device for eliminating or reducing/attenuating the Coandă effect is designed to form a flow stall and/or a separation bubble at least partially and/or regionally on the region of the inner wall of the housing and/or on the wall region of the at least one air flow-regulating and/or air flow-deflecting element and/or on the air flow-conducting wall region inside and/or outside the housing when flow passes through the air vent, in particular with air flow deflection.

In other words, the device for eliminating or reducing/attenuating the Coandă effect is in particular configured to deliberately induce a boundary layer separation in the corresponding region of the air vent.

The boundary layer separation is a flow-mechanical effect that causes a flow to not follow the contour of a body or surface around which the flow occurs. Downstream of the separation point, between the laminar main flow and the body or wall contour, a swirled region forms, which is also sometimes referred to as dead water or overrun.

A boundary layer separation is caused by a counter-rotating pressure increase. This is the case, for example, if the corresponding wall region of the air vent, at which the boundary layer separation and thus the flow stall is to be induced, has an edge or step protruding into the main flow.

In order to eliminate the Coandă effect in particular in the air flow around the at least one air flow-regulating and/or air flow-deflecting element that is movable relative to the housing and, in particular, pivotably mounted, it is preferable that the device for eliminating or reducing/attenuating the Coandă effect is designed only when air flows through the air vent with air flow deflection, and in particular with a minimum deflection of the air flow, to form a corresponding flow stall and/or a separation bubble at the region of the inner wall of the housing and/or at the wall region of the at least one air flow-regulating and/or air flow-deflecting element and/or at the air flow-conducting wall region inside and/or outside the housing.

In particular, the device for eliminating or reducing the Coandă effect should be designed to generate, when air flows through the housing, in particular with air flow deflection, a flow stall with a separation bubble downstream of the separation region, so that there is no reattachment of the flow to the region of the inner wall of the housing and/or to the wall region of the at least one air flow-regulating and/or air flow-deflecting element and/or to the air flow-conducting wall region inside and/or outside the housing downstream of the separation region.

According to embodiments of the air vent according to the disclosure, it is provided that, in order to form a flow stall and/or a separation bubble in a region of the inner wall of the housing and/or in a wall region of the at least one air flow-regulating and/or air flow-deflecting element and/or in an air flow-conducting wall region inside and/or outside the housing, to which the air flow would apply at least partially or regionally without the device for eliminating or reducing/attenuating the Coandă effect, and/or whose contour the air flow would follow at least partially or regionally without the device for eliminating or reducing/attenuating the Coandă effect, an edge, in particular an edge of an inwardly recessed region, is formed.

In other words, according to the present disclosure, a boundary layer separation is deliberately provoked, and thus a flow stall is provoked, as a result of which a turbulent flow region arises downstream of the separation point, so that the air stream cannot follow the contour of the wall region.

In some ways, this measure represents overcoming a prejudice of the professional world, because laminar air stream is usually strived for in the design and layout of an air vent. However, by inducing boundary layer separation in certain areas, the Coandă effect can be surprisingly eliminated, with the result that the deflection area for the air flow is independent of the Coandă effect and, in particular, optimum air flow deflection with consistent quality is achieved across the entire deflection area.

According to further developments of the last mentioned design variant, in which the device for eliminating or reducing/attenuating the Coandă effect is formed by an edge, in particular by an edge of an inwardly jumping region, it is provided that the edge is formed in a region in which, due to a narrowing of the effective flow cross-section, at least locally an increased flow rate of the air stream occurs.

This measure is based on the knowledge that in the region where the effective flow cross-section is narrowed, resulting in at least locally increased air flow velocity, the static pressure is at a minimum, which facilitates boundary layer separation.

Alternatively or in addition to the design variant, in which the device for eliminating or reducing the Coandă effect is formed by an edge, in particular by an edge of an inwardly jumping region, it is contemplated that the device for eliminating or reducing/attenuating the Coandă effect is designed at least partially as an active device for boundary layer influence.

One possibility for such an active device for influencing the boundary layer is to blow air onto the boundary layer in the region of the inner surface of the inner wall of the housing and/or onto the wall region of the at least one air flow-regulating and/or air flow-deflecting element and/or onto the air flow-conducting wall region inside and/or outside the housing. In particular, air is blown onto the boundary layer on at least one surface of the air vent restricting the air duct.

According to implementations of the active device for influencing the boundary layer, it is envisaged that the active device for influencing the boundary layer has at least one preferably slot-shaped outlet opening, which serves to in particular, to introduce additional air as required or continuously into the air flow passing by the region of the inner wall of the housing and/or the wall region of the at least one air flow-regulating and/or air flow-deflecting element and/or the air flow-conducting wall region inside and/or outside the housing.

It is particularly preferred that the active device for influencing the boundary layer is designed to introduce the additional air into the air flow according to the Venturi principle, in particular as required via the preferably slit-shaped outlet opening.

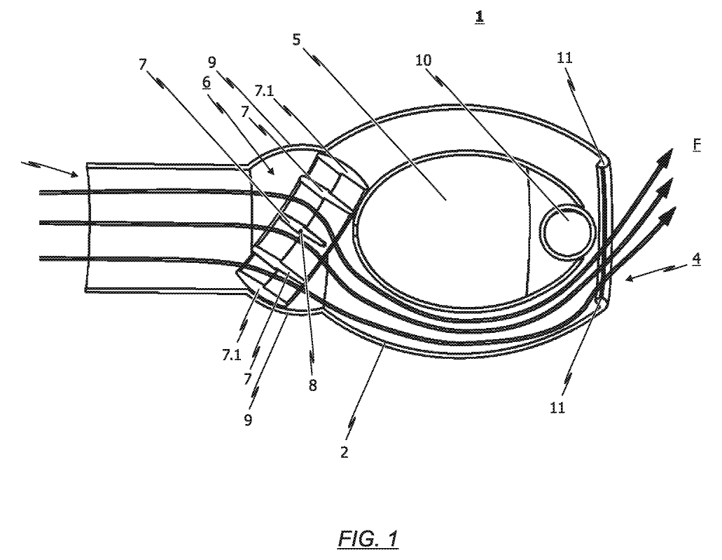

An exemplary embodiment of the air vent 1 according to the disclosure is described in the following, with reference to the accompanying drawings. Specifically, FIG. 2 shows the air vent 1 schematically and in a sectional view, wherein the air vent 1 is in its neutral position. In FIG. 1, on the other hand, the air vent 1 is in a position in which the air flowing through the air vent 1 is deflected upward in the vertical direction to the maximum extent.

The air vent 1 has a housing 2 which forms an air-guiding duct. Accordingly, the housing 2 of the air vent 1 has an upstream air inlet region 3 and a downstream air outlet region 4.

A flow body 5 is arranged inside the housing 2, which, at least in the neutral position of the air vent 1 according to FIG. 2, is completely or at least on both sides surrounded by the air flow F flowing through the housing 2. The flow body 5 is designed to be stationary relative to the housing 2.

In order to be able to deflect the air flow, the air vent 1 also comprises an air-guiding element arrangement 6 with several air-guiding elements 7, 7.1. The air-guiding element arrangement 6 is mounted so that it can pivot about an axis of rotation 8 relative to the housing 2 and relative to the flow body 5 between a neutral position (see FIG. 2) and at least one deflected position (see FIG. 1).

The illustration in FIG. 2 shows in particular that, in its neutral position, the air-guiding element arrangement 6 is arranged – in a main flow direction of the air flow passing through the housing 2 – upstream of the flow body 5 such that, when viewed from above the air outlet region 4 of the housing 2, the air-guiding element arrangement 6 is not optically visible.

The illustration in FIG. 1 shows that the air-guiding element arrangement 6 has several air-guiding elements 7, 7.1 that run at least essentially parallel to one another and which are pivoted together about the common axis of rotation 8 when the air-guiding element arrangement 6 is adjusted. The air-guiding elements 7, 7.1 of the air-guiding element arrangement 6 form a lamellar structure.

In the neutral position of the air-guiding element arrangement 6 shown in FIG. 2, an air duct is formed between two adjacent air-guiding elements 7, 7.1 of the lamellar structure of the air-guiding element arrangement 6, through which a portion of the air flow flowing through the housing 2 of the air vent 1 flows.

It can also be seen from the illustration in FIG. 2 that the outer air-guiding elements 7.1 of the lamellar structure and a corresponding wall section 9 of the housing 2 in the region of the air-guiding element arrangement 6 are designed such that, in the neutral position of the air-guiding element arrangement 6, no air duct through which air can flow is formed between the outer air-guiding elements 7.1 and the wall section 9 of the housing 2.

In the embodiment of the air vent 1 according to the disclosure shown schematically in the drawings, this also applies in the deflected position of the air-guiding element arrangement 6, as can be seen from the illustration in FIG. 1.

In particular, it is envisaged that wall section 9 of housing 2 is curved at least partially or regionally and is designed to complement the outer surface of the corresponding outer air-guiding element 7.1. In particular, the outer surface of the corresponding outer air-guiding elements 7.1 is at least partially or regionally convexly curved.

In the neutral position of the air-guiding element arrangement 6, the flow body 5 is surrounded by air or can be surrounded by air on two opposing sides. In the maximum deflected position of the air-guiding element arrangement 6, however, the flow body 5 is surrounded by air or can be surrounded by air on only one side.

In the exemplary embodiment of the air vent 1 according to the disclosure shown in the drawings, the flow body has an egg-shaped, oval-shaped, or drop-shaped embodiment when viewed in cross-section along the flow direction.

Furthermore, in the embodiment of the air vent 1 according to the disclosure shown in the drawings, it is provided that a wall region of the housing 2 in the region of the flow body 5 runs at least essentially parallel to a surface of the flow body 5 opposing the wall region of the housing 2. At least in the neutral position of the air-guiding element arrangement 6, a flow channel with an at least essentially constant effective flow cross-section is formed between the wall region of the housing 2 and the surface of the flow body 5 opposing the wall region of the housing 2.

In the fully deflected position of the air-guiding element arrangement 5 shown, for example, in FIG. 1, at least one region of the flow channel formed between the wall region of the housing 2 and the surface of the flow body 5 opposing the wall region of the housing 2 is blocked for air flow, in particular by the outer air-guiding element 7.1.

The air-guiding element arrangement 6 is gimballed, in particular.

The drawings also indicate that the air vent according to the disclosure has a control element 10 that can be actuated manually, in particular, wherein the control element 10 is at least partially or regionally incorporated or integrated in the flow body 5. Alternatively, it is also conceivable that the control element 10 is arranged at least partially or regionally on the housing 2 of the air vent 1.

The control element 10 is also mounted on a gimbal and designed to manipulate the air-guiding element arrangement 6 in the opposite direction when the control element 10 is actuated.

The drawings also show that the housing 2 of the air vent 1 has a separation edge 11 at the air outlet region 4 which protrudes into a flow channel of the air vent 1 and, in particular, projects into it.

With the air vent 1 according to the disclosure, no movements of the air flow-guiding elements, i.e., the air-guiding arrangement 6 with the air-guiding elements 7, 7.1, are visible from the vehicle interior.

The proposed solution also meets further requirements for low pressure loss with the required air directionality to reach target points.

The proposed solution also involves simple kinematics.

To achieve air deflection, an air-guiding element arrangement 6 with lamellar structures is pivoted around at least one axis of rotation 8 upstream of the flow body 5, as shown in FIG. 1. This creates an at least partially closed region and an at least partially open region in conjunction with the flow body 5. As a result, the air is directed primarily into the region around the flow body 5 that has been opened by the air-guiding element arrangement 6. The air flow F is guided between the housing 2 and the flow body 5 and directed towards the outflow edge/separation edge 11.

The air deflection preferably occurs through the interaction of the shape of the housing 2, the shape of the flow body 5, and the outflow edge/separation edge 11.

In the neutral position of the air-guiding element arrangement 5, the air flow partial body or flow body 5 is surrounded by air flowing evenly on two opposing sides.

The result is a neutrally directed air flow F (FIG. 2).

### Description of kinematics:

In manual operation, the proposed concept for suspending the air-guiding element arrangement 6 preferably uses a gimbal suspension. This allows the air-guiding element arrangement 6 to be swiveled around two axes and thus into any position around a pivot point.

Similarly, the control element 10 is preferably suspended.

By appropriately coupling control element 10 and air-guiding elements 7, 7.1, a counter-movement of air-guiding element arrangement 6 and control element 10 is achieved. If control element 10 is moved in the direction of the expected air flow, i.e., downwards, air-guiding elements 7, 7.1 are moved in opposite directions so that the air-guiding elements 7, 7.1 direct the air into the upper region between the air flow partial body or flow body 5 and the housing 2, or the lower region is at least partially blocked.

The shape of the housing 2, the shape of the air flow body or flow body 5, and the design of the outflow edge/separation edge 11 direct the air flow F downward.

This applies mutatis mutandis in the same way to outflow in a different direction.

While the present device and/or system have been described with reference to certain examples, it will be understood by those skilled in the art that various changes may be made and equivalents may be substituted without departing from the scope of the present device and/or system. In addition, many modifications may be made to adapt a particular situation or material to the teachings of the present disclosure without departing from its scope. For example, components of disclosed examples may be combined, divided, re-arranged, and/or otherwise modified. Therefore, the present device and/or system are not limited to the particular examples disclosed. Instead, the present device and/or system will include all examples falling within the scope of the appended claims, both literally and under the doctrine of equivalents.

### List of reference numerals

1 Air Vent

2 Housing

3 Air Inlet Region

4 Air Outlet Region

5 Flow Body

6 Air-Guiding Element Arrangement

7 Air-Guiding Element

7.1 Outer Air-Guiding Element

8 Axis Of Rotation

9 Wall Section Of The Housing

10 Control Element

11 Separation Edge

F Air Flow

What is claimed is:

1. An air vent (1) for a motor vehicle, the air vent (1) comprising:
a housing (2) having an air inlet region (3) and an air outlet region (4);
a flow body (5) arranged at least partially in the housing (2) and around which an air flow (F) flowing through the housing (2) can flow, which flow body is designed to be stationary relative to the housing (2); and
an air-guiding element arrangement (6) having at least one air-guiding element (7, 7.1), wherein the air-guiding element arrangement (6) is mounted to be pivotable relative to the housing (2) and relative to the flow body (5) between a neutral position and at least one deflected position about at least one axis of rotation (8),
wherein the air-guiding element arrangement (6) is arranged at least in its neutral position – as seen in a main flow direction of the air flow (F) flowing through the housing (2) – upstream of the flow body (5), such that the air-guiding element arrangement (6) is not optically visible in a top view of the air outlet region (4) of the housing (2) of the air vent (1).

2. The air vent (1) according to claim 1,
wherein the air-guiding element arrangement (6) has a plurality of air-guiding elements (7, 7.1) extending at least essentially parallel to one another which, when the air-guiding element arrangement (6) is adjusted, are pivoted together about one of the at least one axis of rotation (8) as a common axis of rotation (8), wherein the air-guiding elements (7, 7.1) of the air-guiding element arrangement (6) form a lamellar structure.

3. The air vent (1) according to claim 2,
wherein, at least in the neutral position of the air-guiding element arrangement (6), an air duct is formed between two adjacent air-guiding elements (7, 7.1) of the particularly lamellar structure, through which a portion of the air flow (F) flowing through the housing (2) flows.

4. The air vent (1) according to claim 2,
wherein at least one outer air-guiding element (7.1) of the particularly lamellar structure and/or a wall section (9) of the housing (2) in the region of the air-guiding element arrangement (6) are designed such that, particularly in the neutral position of the air-guiding element arrangement (6) and in the at least one deflected position of the air-guiding element arrangement (6), no air duct through which air flows is formed between the at least one outer air-guiding element (7.1) and the wall section (9) of the housing (2).

5. The air vent (1) according to claim 4,
wherein the wall section (9) of the housing (2) is at least partially or regionally curved and is designed to be complementary to an outer surface of the at least one outer air-guiding element (7.1), wherein the outer surface of the at least one outer air-guiding element (7.1) is at least partially or regionally convexly curved.

6. The air vent (1) according to claim 1,
wherein – at least in a neutral position of the air-guiding element arrangement (6) – air flows around or can flow around the flow body (5) at least on two opposing sides.

7. The air vent (1) according to claim 7, wherein, viewed in cross-section along the flow direction, the flow body (5) has an egg-shaped, oval-shaped, or drop-shaped embodiment.

8. The air vent (1) according to claim 1,
wherein a wall region of the housing (2) in the region of the flow body (5) runs at least essentially parallel to a surface of the flow body (5) opposing the wall region of the housing (2), and wherein – at least in the neutral position of the air-guiding element arrangement (6) – a flow channel is formed between the wall region of the housing (2) and the surface of the flow body (5) opposing the wall region of the housing (2) with an at least essentially constant effective flow cross-section.

9. The air vent (1) according to claim 8,
wherein, in a fully deflected position of the air-guiding element arrangement (6), at least one air-guiding element (7, 7.1) of the air-guiding element arrangement (6) blocks at least one region of the flow channel formed between the wall region of the housing (2) and the surface of the flow body (5) opposing the wall region of the housing (2) for air to flow through.

10. The air vent (1) according to claim 1,
wherein the air-guiding element arrangement (6) is gimballed.

11. The air vent (1) according to claim 1,
wherein the air vent (1) comprises a control element (10) that can be actuated manually for manipulating the air-guiding element arrangement (6) as required, wherein the control element (10) is at least partially or regionally incorporated or integrated into the flow body (5), or wherein the control element (10) is arranged at least partially or in part on the housing (2) of the air vent (1).

12. The air vent (1) according to claim 11,
wherein the control element (10) is gimballed and designed to manipulate the air-guiding element arrangement (6) in an opposite manner when the control element (10) is actuated.

13. The air vent (1) according to claim 1,
wherein the housing (2) has a separation edge (11) at the air outlet region (4) of the housing (2) that protrudes into a flow channel of the air vent (1) and projects into it.

14. The air vent (1) according to claim 1,
wherein the air vent (1) has a device which is designed to eliminate or at least reduce or attenuate the Coandă effect occurring when the air flow (F) is deflected from the main flow direction at a region of the inner wall of the housing (2) and/or at a wall region of the at least one air-guiding element.

15. A motor vehicle with an air vent (1) according to claim 1.
